(19) United States
(12) Patent Application Publication
(10) Pub. No.: US 2014/0019993 A1
(43) Pub. Date: Jan. 16, 2014

(54) Tunneling Application Plug-Ins, Systems and Methods

(71) Applicant: Lantronix, Inc., Irvine, CA (US)

(72) Inventor: Alok Mathur, Rancho Santa Margarita, CA (US)

(21) Appl. No.: 13/939,130

(22) Filed: Jul. 10, 2013

Related U.S. Application Data
(60) Provisional application No. 61/669,888, filed on Jul. 10, 2012.

(51) Int. Cl. G06F 9/54

(52) U.S. Cl. CPC G06F 9/54
USPC 719/313

(57) ABSTRACT

A device server capable of adapting to a data flow through the use of plug-ins is presented. The device server manages data flow between data ports through the use of a data flow application. Additionally, the device server stores a collection of data flow plug-ins capable of modifying the data flow application based on plug-in parameters associated with each of the data flow plug-ins. These parameters can be used to describe the nature or functionality of each plug-in. The device server is environmentally aware and is capable of determining which plug-ins are desirable or should be made available at any given time based on environmental context. The device server can then select one or more of the desirable plug-ins and integrate the plug-ins' functionality with the data flow application forming a modified data flow rule set. The integrated data flow rules set dictates data flow between the data ports.

This application claims benefit of U.S. Provisional Application No. 61/669,888, filed Jul. 10, 2012. U.S. Provisional Application No. 61/669,888 and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling

### FIELD OF THE INVENTION

The field of the invention is communications technologies.

### BACKGROUND

The rapidly evolving networking industry introduces new standards and innovations at a rate that often outpaces the adoption of electronic hardware. Devices have been created to allow users to remotely network, access and manage older, legacy electronic equipment through the use of newly introduced or rapidly changing networking protocols. Such devices are designed to serve several vertical markets that utilize legacy electronic hardware, including industrial and building automation, security and fire control, medical, retail, transportation and government. The remaining challenge is to conceive of ways in which such devices can be compatible with a wide range of communication and data transfer protocols, both presently available and still to be developed. Further, such devices should be customizable in the manner in which they transfer and manipulate data and adapt to changes in data transfer technologies. Such customization could, for example, be enabled through the use of software plug-ins. Therefore, it would be beneficial to develop remote networking devices with an ability to shift between implementing one protocol altering plug-in or another plug-in seamlessly, especially in contexts where the remote networking device could make use of many possible plug-ins.

Others have put forth effort toward developing systems and methods of using plug-ins to activate, alter or extend computing processes. For example, U.S. Pat. No. 7,562,369 to Salamone titled “Method and System for Dynamic Configuration of Activators in a Client-Server Environment,” issued Jul. 14, 2009, discusses the use of plug-ins to activate computing processes. Salamone, however, does not discuss altering or extending currently activated computing processes.

U.S. Pat. No. 8,051,191 B2 to Manchanda titled “Ethernet Extensibility,” issued Nov. 1, 2011, further contemplates the use of extensibility functions for networking applications, where the extensibility functions alter or extend upon data processing protocols. Still, Manchanda does not discuss the use of extensibility functions to affect device servers or tunneling applications, for example, functions designed to affect protocols used to network, access or manage legacy electronic equipment over the Internet.

U.S. Pat. No. 7,912,822 to Bethlehem titled “System and Method for Launching a Resource in a Network”, issued Mar. 22, 2011, discusses the use of a plug-in to affect tunneling protocols in a networking environment. However, Bethlehem fails to provide insight into allowing an application to select one or more services provided by plug-ins chosen from a set or the publication of all available plug-ins that can potentially be used.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints and open-ended ranges should be interpreted to include commercially practical values. Similarly, all lists of values should be considered as inclusive of intermediate values unless the context indicates the contrary.

The above references do not address circumstances where a networking device, such as a device server or generic tunneling application, could use one of several applicable plug-ins to activate, affect, or extend data processing protocols in various manners. In such circumstances it would be beneficial to have a method for efficiently publishing and sorting through available plug-ins in a manner that allows for the selective use of one or more applicable plug-ins as dictated by device or application circumstances. Thus, there is still a need for networking devices capable of selectively using protocol enhancing plug-ins from a published plug-in registry.

### SUMMARY OF THE INVENTION

The inventive subject matter provides apparatus and systems in which one can manage data flow between two or more data ports and provide additional functionality to the apparatus, systems and methods through plug-in applications. One aspect of the inventive subject matter includes a device comprising a memory, a registration module, and a data flow manager. The memory can be used to store a data flow application, data flow plug-ins, and a plug-in registry, wherein the plug-in registry can store plug-in parameters associated with the data flow plug-ins.

The plug-in parameters can be used to describe the nature or functionality of the plug-in, a context in which the plug-in might be suitable, or otherwise identify the plug-in among other plug-ins.

The registration module can publish available plug-ins from the plug-in registry according to the plug-in parameters, thereby indicating which plug-ins have services that are available to the data flow application. The publication of the plug-ins can be based on the application's environmental context, usable in managing the data flow.

The data flow manager can be configured to select at least one of the available plug-ins based on the plug-in parameters and to integrate plug-in data flow rules from selected plug-ins with the data flow application forming an integrated data flow rule set. Once an integrated data flow rule set is formed, data flow can be managed between two or more data ports according to the integrated rules set.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 provides an overview of the deployment environment of the device server.

FIG. 2 is a schematic of a device server apparatus with a data flow application where plug-ins provide additional services to the application.

### DETAILED DESCRIPTION

It should be noted that while the following description is drawn to a device server, various alternative configurations are also deemed suitable and may employ various computing devices including servers, interfaces, systems, databases, agents, peers, engines, controllers, or other types of computing devices operating individually or collectively. One should appreciate the use of such terms are deemed to represent computing devices comprising a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within a networking context as discussed within this document, the terms “coupled to” and “coupled with” are also used euphemistically to mean “communicatively coupled with”.

One should appreciate that the disclosed techniques provide many advantageous technical effects including managing data flow between devices utilizing dissimilar data exchange protocols, altering or extending the data flow process using software plug-ins, and providing a method in which the set of available software plug-ins can be regularly updated and made known to the data flow application through a published list.

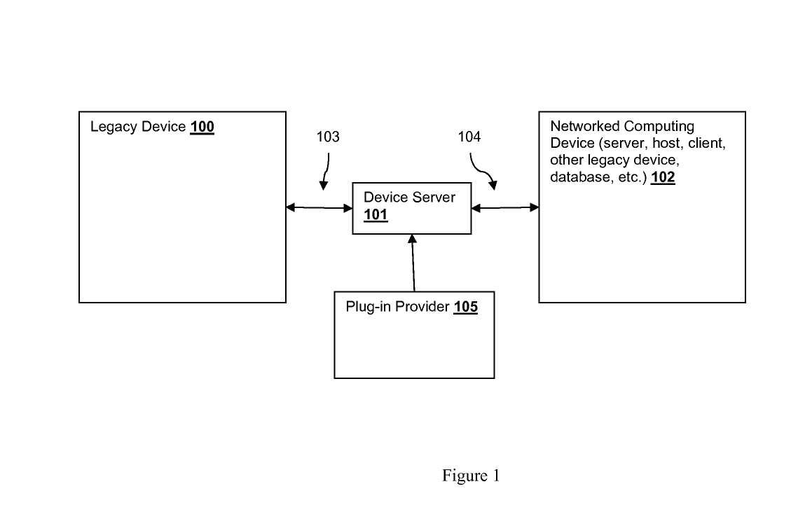

FIG. 1 provides a general overview of a sample deployment environment of the device server 101. As shown in FIG. 1, the device server 101 connects to a legacy device 100 via communication interface 103, and a second computing device 102 via communication interface 104. The illustrated example of FIG. 1 shows a legacy device 100 and that second computing device 102 can be a second legacy device, a networked computing device (e.g., one or more servers, hosts, etc.), a database, etc. However, in embodiments, the legacy device 100 can be other kinds of electronic or computing devices.

The communication interfaces 103 and 104 shown in FIG. 1 can be any kind of communication interface used to communicate or exchange data. Examples can include wireless or wired communication interfaces, and near or long-range communication interfaces. The communication interfaces 103 and 104 are shown in FIG. 1 to both be bi-directional communication, indicative of the fact that both legacy device 100 and computing device 102 can send and receive data transmitted to them by device server 101. However, in embodiments, one or both of the communication interfaces 103 and 104 can be one-directional.

Device servers provide network connectivity to legacy electronic devices lacking desirable native connectivity or a desired type of connectivity. Such legacy devices can include appliances, control panels, vending machines, medical devices, construction equipment, robots, set top boxes, sensors, or other types of devices. The device servers can enable either wired or wireless connectivity (e.g. communications, reporting or other data exchanges) of the legacy devices over a packet switch network (e.g. the Internet, LAN, WAN, WLAN, etc.). The legacy device 100 enabled with a device server can be further connected to one or more databases. As used herein, “database” should be construed to mean a computing device configured to store data in and retrieve data from a storage device (e.g. RAM, ROM, file system, HDD, SSD, CD, DVD, NAS, SAN, RAID system, etc.), possibly in response to one or more queries. The database computing device can be configured with database software that, when executed, allow the database to perform its functions and processes. Examples of database software include Access, MySQL, PostgreSQL, file system, or other commercially available database software. Further, the device server can be considered to configure the legacy device to interact with the database, a file system, or other form of data storage.

The system can also include one or more plug-in sources 105 that can provide new plug-ins, updated plug-ins and other kinds of data (firmware and software updates, new functionality applications, etc.) to the device server 101. A plug-in source 105 can be a local or remote server, host or other kind of computing or networked storage device communicatively coupled with the device server 101. Data such as a new or updated plug-ins can be pushed to the device server 101 periodically, or can be requested periodically or as needed by the device server 101.

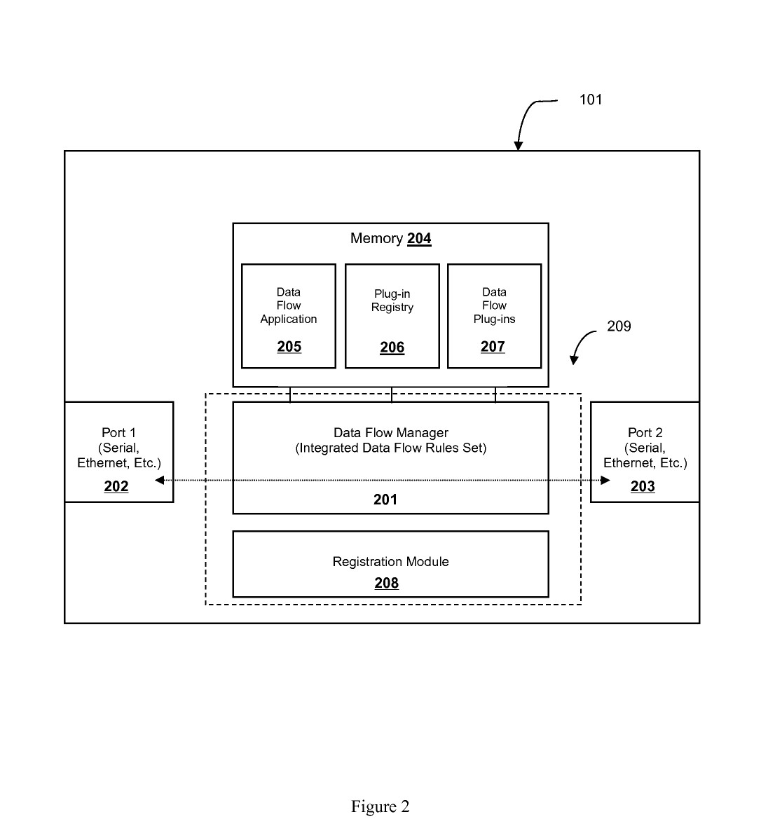

As shown in FIG. 2, the device server 101's data flow manager 201 is communicatively coupled to a memory 204 which stores a data flow application 205, a plug-in registry 206, and data flow plug-ins 207. The memory 204 is a non-transitory computer readable medium (e.g., hard drive, solid state drive, RAM, flash, ROM, etc.). The device server 101 also includes a registration module 208. The data flow application 205, as discussed, can be a dedicated data flow application or a generic data flow application, the data flow application 205 being extensible via one or more of the data flow plug-ins 207. One or more of the data flow manager 201 and registration module 208 can each be a dedicated processor specially programmed to carry out its corresponding functions associated with the inventive subject matter. Alternatively, the data flow manager 201 and registration module 208 can be embodied as computer readable instructions that are also stored on memory 204 and executed by one or more processors 209 (illustrated via the dotted line box in FIG. 2) within the device server 101 to carry out the functions of the inventive subject matter.

The data flow manager 201 can have a dynamic relationship with at least two data ports 202, and 203. While FIG. 2 illustrates a device server 101 with data ports 202 and 203, the device server 101 can include an additional number of ports (e.g., 2, 4, 8, 16, 32, 48, etc.) depending on the nature of the device server 101. Further, the ports can comprise a homogenous or heterogeneous mix of ports. For example, data ports 202 and 203 can each comprise a wired port, wireless port, a bus interface, a memory interface, a serial port, an Ethernet port, or other types of communication ports or interfaces.

The device server's ports 202 and 203 can be wired or wireless as previously mentioned. Each port can exchange data by way of one of many possible interfaces such as serial, Ethernet, FireWire, USB, RS-232, RS-485, RS-422, 801.11(e.g., a, b, g, n, s, etc.), cellular, short range, etc. At least one of the data ports can interface with a legacy electronic device.

In an embodiment, the device server's data flow manager 201 utilizes a generic, general purpose data flow application 205 that is agnostic with respect to data content flowing through ports 202 and 203. An example of such a data flow application could be a tunneling application configured to take raw data from the legacy electronic device and encapsulate the data into a networking protocol (e.g. TCP, UDP, HTTP, SSL, SSH, FTP, WSDL, XML, etc.). Such a configuration allows for a device server to be capable of being deployed across a wide spectrum of applications without modification.

In some situations, one or more of the generic device server's data ports 202 and 203 could each be connected to any one of many possible legacy electronic devices 100,102 such as a computer, printer, server, modem, sensor, hard drive, monitor, camera, audio peripheral, medical diagnostic tool, musical instrument, or other types of device. Alternatively, one or more of the data ports 202 and 203 could be connected to an external network or database. It should be appreciated that a generic device server 101 could include tens, hundreds, or more rule sets to govern data flow between such a variety of devices and communication standards where the rule sets can be applied depending on a device server's environmental context. Preferred rule sets can be embodied as plug-ins within the device server 101.

In some embodiments, the device server's data flow manager 201 utilizes a data flow application that is a dedicated application designed to function with a specific legacy device or set of legacy devices, or designed to utilize a specific networking protocol or packet switch network. For example, a dedicated application can be designed to convert a serial command protocol from an appliance to a network management system based on SNMP.

The devices 100 and 102 connected to each data port could be swappable or frequently changed, which can affect the environment context. In such scenarios the device server can dynamically switch between data flow rule sets as dictated by frequent changes in device or application circumstances. Thus, the device server 101 preferably is environmentally aware. As the device server's environmental context changes, it can dynamically switch between rule sets.

In an embodiment, the device server's data flow manager 201 can use a general purpose data flow application that is extensible via data flow plug-ins comprising one or more rule sets. Further, such a device server 101 is capable of selectively applying the data flow plug-ins as or when desired according to selection criteria that depend on the parameters associated with the plug-ins as well as the environment context of the device server 101.

The plug-in registry 206 stores plug-in parameters associated with each of the data flow plug-ins 207. The plug-in parameters can be used to describe the nature or functionality of the plug-ins as well as the applicable deployment environments or situations. For example, plug-in parameters can include functionality parameters dictating how the plug-in operates. Examples of functionality parameters include application program interface (API) information, software or module contracts, licensing information, authorization or authentication information, plug-in identifiers (e.g., GUID, UUID, etc.), plug-in permissions, version numbers, a plug-in function or purpose, plug-in stack position, plug-in resource requirements, plug-in class, plug-in boot sequence information, activation period information (e.g., when a plug-in is authorized to operate or be made available), or other parameters. Still further, the plug-in parameters can include environmental parameters. The environmental parameters can include parameters such as applicable data types or modalities, a timestamp, application identifier, an application purpose or function, temperature, pressure, movement, a time, a make or manufacturer of the legacy device, one or more protocols, or other information about the environment in which the device server finds itself Environmental parameters can also correspond to characteristics associated with a device server's environmental context.

The device server's environmental context can be one or more characteristics related to the environmental and operational conditions both internally to and externally from the device server 101. Examples of environmental context characteristics include an internal state of the device server, device server performance metrics, an external state of the device server, a state of the legacy device or devices (e.g. operational state, current operations being performed, state of data output, sensor readings, etc.), current data flow metrics, sensor readings such as internal device server temperature, external environmental temperature, humidity, pressure, externally detected movement, power consumption, or any other attributes or properties that could potentially affect plug-in selection.

Plug-in parameters can also include administrator- or user-defined rules or conditions specific to publication that can override a default selection criteria or prioritize other plug-in parameters.

The registration module 208 publishes a set of data flow plug-ins 207 that are available for use by the data flow application 205 according to a publication criteria for each of the plug-ins. The publication criteria of a plug-in can include a collection of plug-in parameters that must be satisfied for a plug-in to be published.

The data flow manager 201 selects at least one of the available plug-ins published by the registration module 208 for use with the data flow application. The selection criteria used by the data flow manager 201 can include some or all of the publication criteria, as well as additional plug-in parameters. For example, the publication criteria can be a selection of plug-in parameters corresponding to both functionality and environmental context of a categorical or high-level nature. The selection criteria, in turn, could include some or all of those same plug-in parameters, and also additional plug-in parameters related to more detailed aspects of functionality and/or environmental context, such as specific situational parameters.

Alternatively, the selection criteria used by the data flow manager 201 can be based on plug-in parameters that are not included in the publication criteria. In one example, the publication criteria can be a subset of all plug-in parameters and the selection criteria can be a different subset of all plug-in parameters, with no overlap between the two subsets. In another example, the publication criteria used by the registration module 208 can be based plug-in parameters associated with functionality as described above. The selection criteria used by the data flow manager 201, on the other hand can be based on the environmental parameter examples described above. In this example, then, the registration module 208 can publish a list of plug-ins related to a particular function or purpose related to a particular data flow or application. The data flow manager 201 can then, in turn, select one or more plug-ins from the culled list that best fit the situational or environmental state or conditions of operation.

Each of the registration module 208 and the data flow manager 201 can perform selections of plug-ins for publication and integration, respectively, in various ways. For example, the selections can be performed periodically, in response to queries, triggering conditions or situations, or the presence of particular functional, operational or environmental context parameters.

In one example, the registration module 208 and/or data flow manager 201 can receive parameters related to the environmental context of the device server 101, the data flow, sensor data, or other data received reflecting conditions internally to or externally from the device server 101, the legacy device 100, the computing device 102, the plug-in provider 105 or any other device in communication with the device server 101. The registration module 208 and/or data flow manager 201 can then associate these received external parameters with the plug-in parameters stored within the plug-in registry 206 to determine whether any corresponding matching or selection criteria are met. Examples of associations that can be performed include a one-to-one correlation of parameters, statistical analysis of parameters, cluster analysis of parameters, query functions, etc. The registration module 208 and/or data flow manager 201 can perform the selection processes periodically, according to a selection schedule, in response to a change in one or more external parameters (e.g. reflecting a change in environmental context), in response to a change in one or more plug-in parameters, in response to a change in connection status, upon boot-up or initializing of the device server 101, in response to changes in the data flow, in response to functions or processes performed by the data flow application 205, or other defined criteria.

The publication of plug-ins can include making application programming interfaces (APIs) available to the device server applications, providing the available plug-ins as a list, or any other step that involves making the available plug-ins known to either the device server applications, the data flow manager 201, or an end user.

In some embodiments, the registration module 208 can be owned or controlled by a third party other than the end user. As a result, a party other than the end user is responsible for determining which plug-ins are published and how the plug-ins are published. Such an approach is considered advantageous when the device servers are modified by a third party integrator or when digital rights management is of concern.

In an illustrative example, the device server 101 can be part of a mobile embodiment, perhaps a delivery truck. The registration module 208 can determine a location of the truck based on GPS information. When the truck reaches a pick up stop, a warehouse for example, the registration module 208 can then make a warehouse-specific plug-in available to the tunneling application. Perhaps the truck requires an exchange of inventory information between an on-board database and the warehouse according to a specific protocol or data format. The data flow manager 201 can receive a notification from the registration module 208, possibly in the form of an exception or interrupt. In response, assuming the plug-in is indeed applicable, the data flow manager 201 can then see the available plug-in and integrate the plug-in into the tunneling application 205. The tunneling application 205 utilizes the plug-in by calling its APIs via a plug-in handler.

The data flow manager 201 selects at least one of the available plug-ins published by the registration module 208 and integrates the plug-in data flow rules from selected ones of the available plug-ins with the data flow application 205 to form an integrated data flow rule set. The data flow manager 201 then manages data flow between the first port 202 and the second port 203 according to the integrated data flow rules set.

The integrated rule sets can take on a variety of forms. In some scenarios a plug-in rule set can be in serial with one or more application rules set of the data flow application 205. The integrated rule sets can then form a chain of rules sets, or a set of serial rule sets. Further, data flow through the plug-in can passed through the plug-ins exclusively and bypass the application rules set. In this example, the data flow can then be switched back and forth between the application or other plug-ins, or can run in parallel. Thus, the integrated rule sets can include parallel rule sets all operating on the data flow.

Plug-ins can include one or more data handlers that are called or triggered upon satisfying handler conditions. The handlers can be used to filter data from the data flow, inject data into the data flow, or otherwise manipulate data within the data flow.

The plug-ins can include one or more listeners that cause the data flow manager 201 to act based on satisfaction of triggering criteria. The data flow listeners can operate as a function of many different factors including data within the data flow, device server state, legacy device state, or other information. When the listener is triggered, the data flow manager can take a corresponding action, possibly comprising providing a notification through ports 202 or 203, logging an event, updating rule sets, registering plug-ins, throwing an exception, handling an exception, inserting rule sets, removing plug-ins or rule sets, managing listeners, configuring a connected device, or other actions.

The data flow plug-ins 207 can include plug-in management actions. The plug-in management actions can include instructions that affect the use of a particular plug-in beyond merely integrating the plug-in into the data flow application. The plug-in management actions can also include additional parameters associated with the plug-in management actions that can affect whether a particular plug-in is published by the registration module 208 or selected by the data flow manager 201.

The plug-in management actions can include instructions for removing an already integrated plug-in from the integrated data flow. The removal can be time-based (i.e., the integration of the plug-in is for a pre-set time known or determined at the time of integration, after which the plug-in is removed) or condition-based, based upon the plug-in parameters and a changed environmental context. For example, if the plug-in parameters and current environmental conditions dictate that a particular plug-in is no longer necessary, the plug-in management actions can indicate to the data flow manager 201 to remove the already-integrated plug-in from the application.

The plug-in management actions can also include instructions to replace an existing plug-in with a published, un-integrated plug-in. This can be based on parameters of the existing plug-ins and the published, potential plug-ins. The parameter plug-ins can be those described elsewhere in this specification, and can be used by the data flow manager 201 to compare the integrated and published plug-ins directly or compare how the plug-ins will affect the integrated data flow. For example, the version numbers of an integrated plug-in and a published plug-in can be compared by the data flow manager 201 to replace an older version of the plug-in with an updated version of the same plug-in. In another example, factors associated with the overall functionality, the instant functionality, as well as resource requirements of the integrated plug-in (can be one integrated plug-in or more than one functioning collectively) and one or more published plug-ins can be compared to determine whether one or more of the published plug-ins can accomplish the instant or overall desired services or functions of the already-integrated plug-ins more efficiently, such as with lower memory or processing requirements. The flow manager 201 can replace the existing, integrated plug-in(s) with one or more published plug-ins that suit the instant and/or overall needs of the data flow more efficiently, thereby streamlining the data flow management functions of the data flow manager 201 on the fly.

In embodiments where the data flow plug-ins 207 include plug-in management actions, the registration module 208 publishes the available plug-ins as described above, and the data flow manager 201 can then select one or more plug-ins from the published plug-ins. Either as part of the selection of the plug-ins, or following the selection, the flow manager 201 analyzes the plug-in management actions related to the selected plug-ins and performs the actions corresponding to the plug-in management actions.

In implementations where the data flow manager 201 deletes or replaces an existing, integrated plug-in, the data flow manager 201 must be able to determine the existence of one or more plug-ins subject to removal or replacement within the integrated data flow. In one example, the memory 204 can include a plug-in integration history that can include entries of previously-integrated plug-ins and removed plug-ins. The data flow manager 201 can then perform a look-up of all of the plug-ins currently integrated. Alternatively, the data flow rules integrated into the application from one or more plug-ins can contain identifiers that identify the plug-ins to which the data flow rules belong, the identifiers being recognizable by the data flow manager 201.

A plug-in can be implemented through various techniques. In some embodiments, the plug-in can include compiled code compatible with the operating system of the device server. It is also contemplated that the device server can include one or more scripting engines (e.g., Python, Perl, Cobra, etc.). In such cases, the plug-in can include a script file. In still other embodiments, the device server can include one or more virtual machines (e.g., Java, .NET, etc.). In which case, the plug-in can include intermediary byte code files. Regardless of the form of the plug-in, the plug-in can represent a distinct object with the device server that can be separately managed from the tunneling application.

The device server 101 can additionally include a plug-in interface through which the device server 101 can receive new plug-ins from the plug-in source 105. Example plug-interfaces can include a web server that accepts an HTTP post comprising plug-in code, an FTP server, an API, a file server, a bus, a memory connection, ports 202 or 203, or other type of interface. Further, the interface preferably provides for receiving, storing, registering, or otherwise managing plug-ins.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A device server comprising:
a first data port and a second data port;
a memory storing a data flow application, a plug-in registry, and data flow plug-ins, wherein the plug-in registry stores a plurality of plug-in parameters associated with the data flow plug-ins;
a registration module that publishes available plug-ins from the plug-in registry and according to a first set of plug-in parameters from the plurality of plug-in parameters; and
a data flow manager configured to:
select at least one of the available plug-ins based on a second set of plug-in parameters from the plurality of plug-in parameters,
integrate plug-in data flow rules from the selected at least one plug-in with the data flow application to form an integrated data flow rules set, and
manage a data flow from the first port to the second port according to the integrated data flow rules set.

2. The device server of claim 1, wherein the integrated rules set comprises at least one of the following: a chain of rules sets, parallel rules sets, and serial rules sets.

3. The device server of claim 1, wherein plug-in data flow rules from the selected ones of the available plug-ins set comprise data flow handlers, wherein the data flow handlers comprise at least one of:
data filters that remove data from the data flow;
data injectors that add data to the data flow; and
data manipulators that change data within the data flow.

4. The device server of claim 1, wherein plug-in data flow rules from the selected ones of the available plug-ins set comprise a data flow listener that causes the data flow manager to take an action upon satisfaction of triggering criteria.

5. The device server of claim 4, wherein the data flow listener operates as a function of data within the data flow.

6. The device server of claim 4, wherein the data flow listener operates as a function of a device state.

7. The device server of claim 6, wherein the device state represents at least one of the device server's state and a state of a second device connected to the first port.

8. The device server of claim 4, wherein the action includes at least one of the following: providing a notification via at least one of the first and the second ports, logging an event, updating the integrated rules set, registering an additional plug-in, throwing an exception, handling an exception, inserting the plug-in data flow rules set, removing the plug-in data flow rules set, manage a listener, and configuring a connected device.

9. The device server of claim 1, wherein the first port comprises a serial port configured to operate according to at least one of the following: RS-232, RS-485, and RS-422.

10. The device server of claim 1, wherein the second port comprises an Ethernet port.

11. The device server of claim 1, further comprising a plug-in interface configured to:
receive at least one new plug-in, each of the at least one new plug-in comprising a corresponding plug-in data flow rules set;
store the new plug-in in the memory; and
register the at least one new plug-in with the plug-in registry by storing at least one plug-in parameter associated with the at least one new plug-in in the plug-in registry.

12. The device server of claim 11, wherein the plug-in interface comprises at least one of the following: an Application Program Interface, a web server, a file server, a bus, a memory connection, the first port, and the second port.

13. The device server of claim 1, wherein the data flow application comprise a tunneling application configured to manage the data flow from a first protocol via the first port to a second, different protocol via the second port.

14. The device server of claim 1, wherein the data flow comprises a packetized stream.

15. The device server of claim 14, wherein the packetized stream comprises packets at or above a network layer of a communication stack.

16. The device server of claim 1, wherein the data flow manager is further configured to select at least one of the available plug-ins as part of a boot sequence of the data flow manager.

17. The device server of claim 16, wherein the registration module is further configured to publish availability of the available plug-ins before data flow manager is initiated.

18. The device server of claim 1, wherein the first set of parameters comprises a subset of the second set of plug-in parameters and the second set of plug-in parameters includes at least one more plug-in parameter than the first set of plug-in parameters.

19. The device server of claim 1, wherein the first set of plug-in parameters comprises one of at least one functionality parameter and at least one environmental parameter and the second set of plug-in parameters comprises the other of the at least one functionality parameter and the at least one environmental parameter.

20. The device server of claim 19, wherein:
the at least one functionality parameter includes at least one of API information, software contracts, module contracts, licensing information, authorization information, authentication information, a plug-in identifier, a plug-in name, a plug-in function, a plug-in purpose, a plug-in service, a plug-in resource requirement, a plug-in class identifier, plug-in boot sequence information, a plug-in stack position, plug-in permission information, activation period information, and a plug-in version number; and
the at least one environmental parameter includes at least one of applicable data flow data types, applicable data flow modalities, applicable data flow application data types, applicable data flow application modalities, a timestamp, a data flow application identifier, a data flow application name, a data flow application purpose or function, a data flow condition, a temperature, a pressure, a movement, a make or manufacturer of the legacy device, a protocol, a data flow metric, a sensor reading, a device server power consumption reading, a port status, a legacy device power consumption reading, a legacy device state, a device server performance metric, a network location, a physical location, a plug-in integration requirement, and an output device state.
